(19) United States
(12) Patent Application Publication
(10) Pub. No.: US 2008/0218577 A1
(43) Pub. Date: Sep. 11, 2008

(54) CONVEYOR BELT WITH LINEAR SCALE, CONVEYOR BELT DRIVING APPARATUS AND PRINTING APPARATUS

(75) Inventor: Toshiyuki Suzuki, Shiojiri-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 11/849,600

(22) Filed: Sep. 4, 2007

(30) Foreign Application Priority Data
Sep. 5, 2006 (JP) 2006-240244
Aug. 17, 2007 (JP) 2007-212553

(51) Int. Cl. B41J 2/01

(52) U.S. Cl. 347/104

(57) ABSTRACT

A printing apparatus for printing characters, figures, or images by ejecting fine liquid from a plurality of nozzles to form fine particles on a print medium. The printing apparatus includes: a conveyor-belt driving system in which a conveyor belt with a linear scale is used, the conveyor belt having a magnetic layer including a magnetic pattern serving as a linear scale on the inner circumference of the conveyor belt along the direction of conveyance of the print medium; scale-pattern detection unit that detects the scale pattern of the linear scale on the conveyor belt; print-timing determination unit that determines the timing to print on the print medium according to the scale pattern detected by the scale-pattern detection unit; and printing unit that prints on the print medium at the print timing determined by the print-timing determination unit.

### BACKGROUND

1. Field of the Invention

The present invention relates to a conveyor belt having a linear scale along the direction of conveyance of print media, and a conveyor belt driving apparatus and a printing apparatus using the same.

2. Description of the Related Art

General fixed-head type printing apparatuses are equipped with a liquid-ejecting head unit having a number of nozzles across the width of print media and in parallel therewith, and eject liquid from the nozzles while relatively moving print media in the direction perpendicular to the width of the print media, thereby printing on the print media.

To execute high-quality printing with printing apparatuses, it is necessary to eject liquid so that dots are formed at regular intervals according to the momentum of the print medium. To this end, general printers eject liquid according to the momentum of the print medium held on the conveyor belt in such a manner that a scale film having a scale pattern is disposed on the front surface of one end of the conveyor belt, the scale pattern of the linear scale is detected by an optical sensor to detect changes in light transmittance as analog electric signals, from which pulse signals are generated, and the timing to eject liquid from the liquid-ejecting head is determined from the pulse signals.

Examples of the sensor for detecting the scale pattern of the linear scale include an optical transmission sensor (for example, refer to JP-A-9-175687) an optical reflection sensor (for example, refer to JP-A-11-170623), and a magnetic sensor (for example, refer to JP-A-6-67480).

However, in the case where the linear scale is disposed on the front surface of one end of the conveyor belt, as described above, the conveying surface and the linear scale are formed on the same surface. Therefore, the sensor must be disposed outside the print-media conveying path so as not to interfere with the conveyance of print media. That is, the belt width must be larger than the maximum width of print media that can be conveyed by the conveyor belt by the width corresponding to the linear scale width, posing the problem of difficulty in downsizing the apparatus.

### SUMMARY

It is an object of the present invention to provide a conveyor belt with a linear scale in which the width of the conveyor belt is reduced so that the whole apparatus can be reduced in size, a conveyor belt driving apparatus and a printing apparatus using the same.

A conveyor belt with a linear scale according to the invention is a conveyor belt for transferring a print medium. The conveyor belt includes a magnetic layer having a magnetic pattern serving as a linear scale on the inner circumference of the conveyor belt along the direction of conveyance of the print medium.

With the arrangement, the conveyor belt has a magnetic layer having a magnetic pattern serving as a linear scale, the flexibility of the material for the conveyor belt is higher than that of an optical transmission scale, and easier to achieve high resolution than that of an optical reflection scale.

A conveyor-belt driving system according to the invention is stretched between a driving roller and a driven roller, wherein a conveyor belt with a linear scale is used, the conveyor belt having a magnetic layer including a magnetic pattern serving as a linear scale on the inner circumference of the conveyor belt along the direction of conveyance of the print medium.

With the arrangement, the width of the conveyor belt can be reduced by the width corresponding to the linear scale as compared with a case in which the linear scale is provided at one end of the length of the conveyor belt.

Furthermore, it is preferable that the portions of the driving roller and the driven roller facing the linear scale each have a circumferentially continuous groove.

With the arrangement, the portions of the rollers facing the linear scale each have a circumferentially continuous groove in which the linear scale can be housed. This prevents the front surface of the linear scale from coming into direct contact with the rollers, thereby preventing the magnetic pattern from wearing due to contact with the driving rollers.

A printing apparatus according to the invention is a printing apparatus for printing characters, figures, or images by ejecting fine liquid from a plurality of nozzles to form fine particles on a print medium. The printing apparatus includes: a conveyor-belt driving system in which a conveyor belt with a linear scale is used, the conveyor belt having a magnetic layer including a magnetic pattern serving as a linear scale on the inner circumference of the conveyor belt along the direction of conveyance of the print medium; scale-pattern detection unit that detecting the scale pattern of the linear scale on the conveyor belt; print-timing determination unit that determines the timing to print on the print medium according to the scale pattern detected by the scale-pattern detection unit; and printing unit that prints on the print medium at the print timing determined by the print-timing determination unit.

The arrangement can reduce the size of the whole printing apparatus, and moreover, reduce the possibility of entrance of foreign matter such as mist into the liner scale and the scale-pattern detection unit by the printing unit, because the scale-pattern detection unit is disposed in the space between the rollers and opposite to the print-medium mounting surface.

It is preferable that the printing unit include a plurality of individually controllable liquid-ejecting head units; the conveyor belt with a linear scale be opposed to the plurality of liquid-ejecting head units; the scale-pattern detection unit be opposed to the plurality of liquid-ejecting head units, with the conveyor belt with a linear scale in between; and the print-timing determination unit determine print timing according to the detection signal of the scale-pattern detection unit opposed to the liquid-ejecting head units.

With the arrangement, the position of the conveyor belt can be detected at the positions of the liquid-ejecting head units. Therefore, in the case where liquid-ejecting head units of different colors are disposed in different positions in the conveying direction, color shift or the like can be prevented even if the conveyor belt has expansion or contraction. In the case where liquid-ejecting head units are disposed along the width of the belt, and when there is a difference in moving speed between the right and left, printing can be performed without being influenced by the difference in moving speed.

It is preferable that the conveyor belt with a linear scale include a plurality of individually controllable divided belts displaced in a staggered configuration in the print-medium conveying direction in such a manner as to be next to each other alternately along the width of the print medium; the printing unit include a plurality of individually controllable liquid-ejecting head units disposed between the divided belts, with a print-medium conveying path sandwiched therebetween; the scale-pattern detection unit be provided individually for the liquid-ejecting head units, in the positions opposed to the linear scales of the divided belts adjacent to the liquid-ejecting head units, with the print-medium conveying path sandwiched therebetween and at same positions as the liquid-ejecting head units in the conveying direction; and the print-timing determination unit determine print timing according to the respective detection signals of the scale-pattern detection unit opposed to the liquid-ejecting head units.

With the arrangement, the scale-pattern detection unit are disposed on the divided belts adjacent to the liquid-ejecting head units, with the print-medium conveying path sandwiched therebetween. Therefore, even if the scale-pattern detection unit cannot be disposed at the positions facing the liquid-ejecting head units, conveyor-belt position detection or print-medium position detection can be performed with high accuracy, allowing printing at accurate print timing.

It is preferable to have foreign-matter protection unit that prevents foreign matter from entering the conveyor-belt inside space formed by the conveyor belt on the sides of the conveyor-belt conveying path.

The arrangement can prevent foreign matter such as mist from entering the liner scale and the scale-pattern detection unit by the printing unit, because the foreign-matter protection unit is provided for preventing foreign matter from entering the conveyor-belt inside space.

### BRIEF DESCRIPTION OF THE DRAWINGS

FIG. 1 is a schematic diagram of a printing apparatus incorporating the invention;

FIG. 2 is a diagram illustrating the position of a magnetic layer;

FIG. 3 is a diagram of an example of a driving roller and a driven roller;

FIG. 4 is a diagram of another example of the conveyor belt;

FIG. 5 is a diagram of an example a mist protection cover;

FIG. 6 is a block diagram of the functional structure of a control unit;

FIG. 7 is a diagram illustrating a method for generating a print reference signal;

FIG. 8 is a block diagram of the functional structure of a print-reference-signal generating circuit when a print reference signal is generated according to the speed of the conveyor belt;

FIG. 9 is a diagram illustrating a method for generating a print reference signal when the print reference signal is generated according to the speed of the conveyor belt;

FIG. 10 is a schematic diagram showing the positions of magnetic sensors of a divided-type liquid ejecting head; and

FIG. 11 is schematic diagram showing the positions of magnetic sensors of a divided belt printer.

### DESCRIPTION OF EXEMPLARY EMBODIMENTS

A first embodiment of the invention will be described hereinbelow.

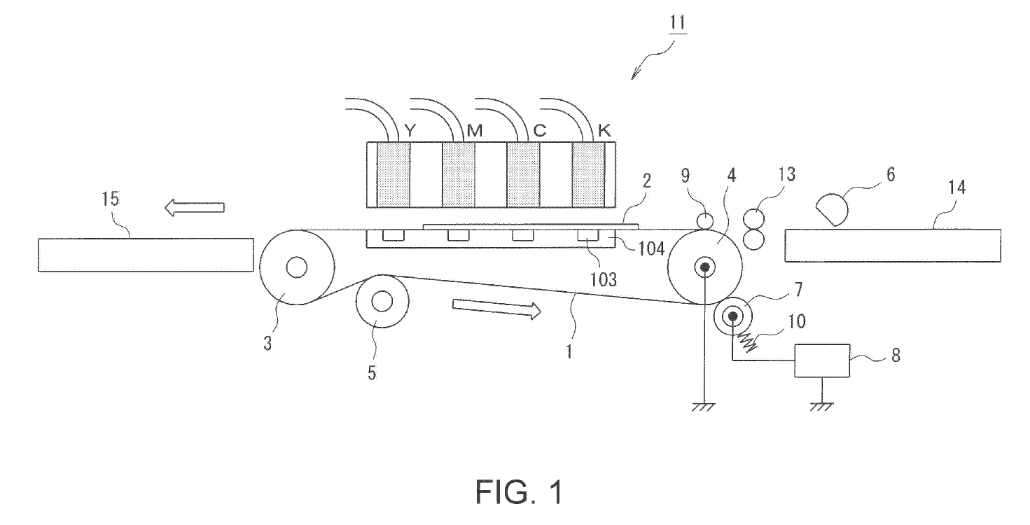

FIG. 1 is a schematic diagram of a printing apparatus of this embodiment.

Reference numeral 1 in the drawing denotes a conveyor belt that is an endless belt for conveying a print medium 2 such as recording paper. The print medium 2 is a sheet-like member such as recording paper or an OHP sheet. The conveyor belt 1 is an insulating belt made of insulating resin such as PET, polyimide, or fluoroplastic. The conveyor belt 1 is wound around a driving roller 3 at the left end of the drawing, a driven roller 4 at the right end of the drawing, and a tension roller 5 below the center therebetween. The driving roller 3 is rotated along the arrow by an electric motor, to be described later, to convey the print medium 2 from the right to the left in the drawing, with the print medium 2 adhered to the conveyor belt 1 charged by a charging roller to be described later. The driven roller 4 is grounded because voltage is applied thereto while sandwiching the conveyor belt 1 between it and the contact of the charging roller described later. The tension roller 5 is urged upward by a spring (not shown), thereby applying tension to the conveyor belt 1.

The charging roller 7 serving as charging unit abuts on the conveyor belt 1 in such a manner as to be opposed to the driven roller 4. The charging roller 7 is connected to a direct-current power supply 8. The charging roller 7 is disposed immediately in front of the print medium 2 feed position. The charging roller 7 charges the front surface of the dielectric conveyor belt 1 with electricity, with which it causes dielectric polarization on the print medium 2, to adhere the print medium 2 to the front surface of the conveyor belt 1 by the electrostatic force caused by the electric charge of the print medium 2 due to the dielectric polarization and the electric charge of the dielectric portion of the front surface of the conveyor belt 1. Numeral 10 in the drawing denotes a spring that pushes the charging roller 7 against the conveyor belt 1.

There is a bail roller 9 on the driven roller 4. The bail roller 9 is urged downward by a spring (not shown), functioning to push the print medium 2 against the conveyor belt 1 on the driven roller 4. As described above, when the print medium 2 is placed on the outer circumference of the charged conveyor belt 1 and pushed against the conveyor belt 1 with the bail roller 9, the print medium 2 is adhered to the outer circumference of the conveyor belt 1 by the dielectric polarization. There is a pair of upper and lower gate rollers 13 upstream from the bail roller 9 in the print medium 2 conveying direction. The gate rollers 13 controls the timing to feed the print medium 2 fed from a paper feeder 14 by a pickup roller 6 onto the conveyor belt 1 and corrects the slant of the print medium 2 with respect to the conveying direction, or so-called skew. Numeral 15 in the drawing denotes a paper output section for outputting the print medium 2.

Numeral 11 in FIG. 1 denotes line-type liquid ejecting heads. The liquid ejecting heads 11 of four colors of yellow (Y), magenta (M), cyan (C), and black (K) are disposed in the positions shifted in the print medium 2 conveying direction from one color to another. The liquid ejecting heads 11 are each supplied with liquid from respective liquid tanks (not shown) via liquid feed tubes. Each liquid ejecting head 11 has a plurality of nozzles in the direction intersecting the print medium 2 conveying direction (hereinafter, also referred to as a nozzle column direction), from which a necessary amount of liquid is ejected to desired portions at the same time to form fine liquid dots on the print medium 2. The foregoing process is performed for each color to enable what-is-called one-pass printing only by passing the print medium 2 adhered to the conveyor belt 1 therethrough. That is, the area of the liquid ejecting heads 11 corresponds to the print area.

Examples of a method for ejecting liquid from the nozzles of the liquid ejecting heads include an electrostatic system, a piezoelectric system, and a film boiling system. The electrostatic system is a system in which when a driving signal is applied to an electrostatic gap serving as an actuator, the diaphragm in the cavity is displaced to cause pressure changes in the cavity, by which liquid is ejected from the nozzles. The piezoelectric system is a system in which when a driving signal is applied to a piezoelectric element serving as an actuator, the diaphragm in the cavity is displaced to cause pressure changes in the cavity, by which liquid is ejected from the nozzles. The film boiling system is a system in which liquid is momentarily heated to 300° or more by a minute heater in the cavity into a film boiling state to generate bubbles, causing pressure changes, by which the liquid is ejected from the nozzles. The invention can adopt any of the liquid ejection systems.

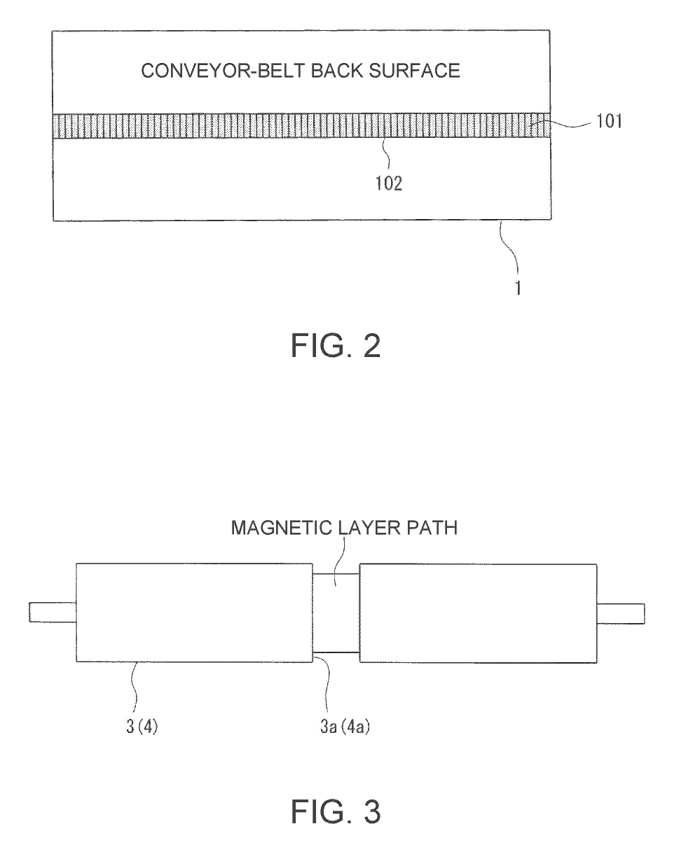

Assuming that the surface on which the print medium 2 is to be placed is the front surface of the conveyor belt 1, the back surface, that is, the inner circumference of the conveyor belt 1 is coated with a magnetic layer 101 of a fixed width having a magnetic lattice pattern 102 in the center of the length to form a linear scale, as shown in the developed view of FIG. 2.

As shown in FIG. 3, the surfaces of the driving roller 3 and the driven roller 4 facing the conveyor belt 1 have circumferential grooves 3a and 4a, respectively, of the size that the magnetic layer 101 can be housed and the surface of the magnetic layer 101 does not come in contact with the driving roller 3 and the driven roller 4, respectively.

In general, the magnetic layer 101 has a thickness of 5 to 10 μm. However, when the conveyor belt 1 is wound around the driving roller 3 or the driven roller 4, the magnetic layer 101 is housed in the groove 3a or 4a, at which the surface of the magnetic layer 101 does not come in contact with the driving roller 3 or the driven roller 4. This allows the front surface of the conveyor belt 1 to be maintained flat, and prevents the magnetic pattern from wearing due to the contact of the surface of the magnetic layer 101 with the driving roller 3 or the driven roller 4.

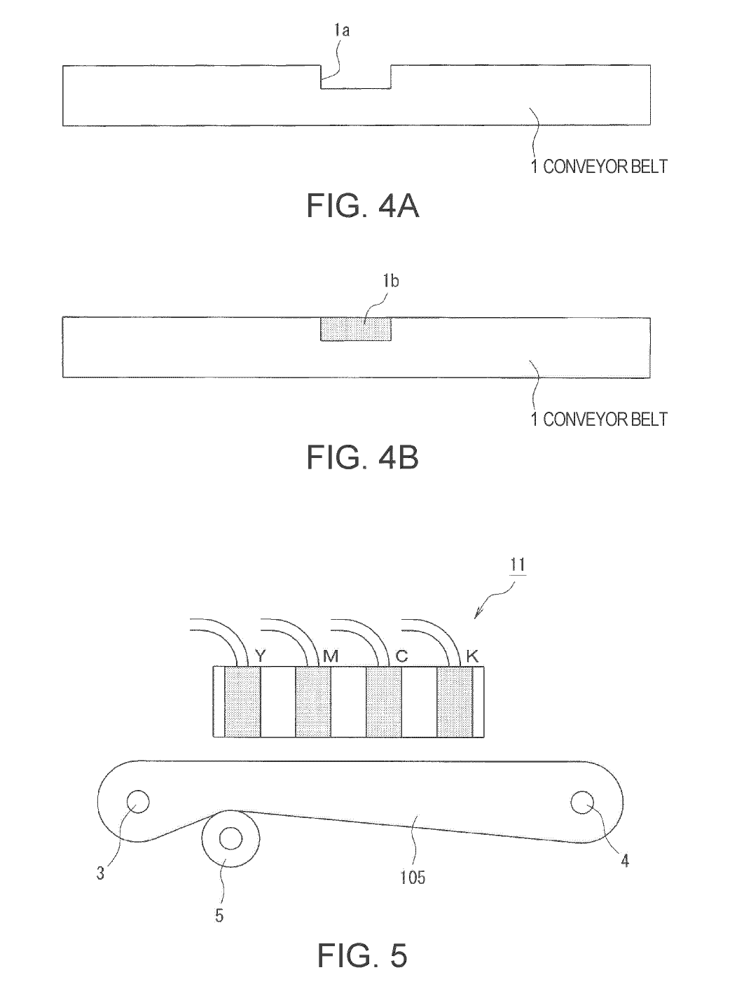

We have described the case in which the front surface of the conveyor belt 1 is maintained flat by forming the grooves 3a and 4a on the driving roller 3 and the driven roller 4, respectively. In contrast, as shown in FIG. 4A, the conveyor belt 1 may have a groove 1a on the back, in which a magnetic layer 1b is formed in such a manner that the surface formed of the conveyor belt 1 and the magnetic layer 1b is flat (FIG. 4B), and a magnetic pattern may be formed on the magnetic layer 1b.

As shown in FIG. 5, a mist protection cover 105 is provided on both sides of the driving roller 3 and the driven roller 4 so as to cover the whole circumference of the conveyor belt 1. This structure prevents mist from entering the inner circumference space of the conveyor belt 1, thereby preventing detection errors of the magnetic lattice pattern 102 due to mist. Although FIG. 5 shows a case in which the mist protection cover 105 is shaped so as to cover the whole conveyor belt 1 along the shape thereof, the shape of the mist protection cover 105 may not be limited to that; it may be of a shape covering the tension roller 5, too. That is, the mist protection cover 105 may be of any shape that can prevent mist from entering the inner circumference space of the conveyor belt 1.

Referring back to FIG. 1, the magnetic pattern 102 formed on the magnetic layer 101 is detected by magnetic sensors 103 or magnetic sensor heads.

The magnetic sensors 103 are disposed in the positions of an insulating platen 104 facing the magnetic pattern 102 and opposed to the color liquid ejecting heads 11, individually, the platen being in contact with the inner circumference of the conveyor belt 1 and over the entire width. That is, four magnetic sensors 103 are disposed in the positions of the platen 104 facing the liquid ejecting heads 11 of four colors, respectively. The magnetic sensors 103 detect the magnetic pattern 102 at the positions directly under the corresponding liquid ejecting heads 11. The platen 104 also has grooves in which the magnetic layer 101 can be housed in the positions facing the magnetic pattern 102 as the driving roller 3 or the driven roller 4 shown in FIG. 3.

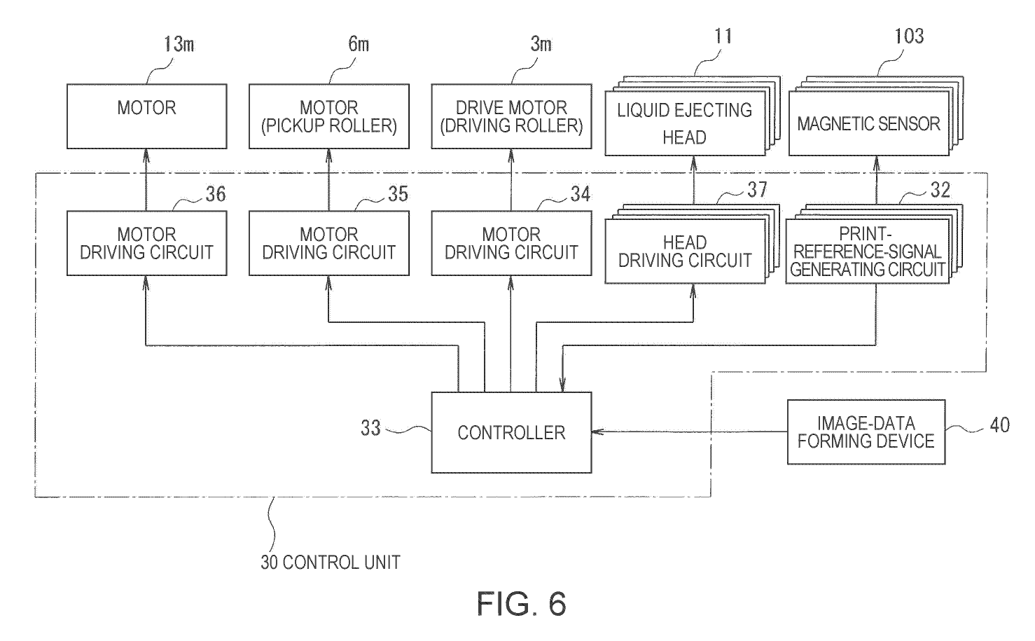

The information detected by the magnetic sensors 103 is input to a control unit 30 for controlling the whole printing apparatus. As shown in FIG. 6, the control unit 30 receives detection signals of the magnetic pattern 102 from the magnetic sensors 103, in addition to the information detected by the magnetic sensors 103, and image data to be recorded on the print medium 2, the image data being output from an image-data forming device 40 that forms image data, such as an external computer or a digital camera.

As shown in the block diagram of FIG. 6, the control unit 30 includes a print-reference-signal generating circuit 32 to which detection signals from the magnetic sensors 103 are input, and which generates print reference signals according to the timing of detection of the magnetic pattern 102 on the conveyor belt 1 according to the detection signals; and a controller 33, for example, a microcomputer, to which the print reference signals generated by the print-reference-signal generating circuit 32 and the image data from the image-data forming device 40 are input. The control unit 30 further includes motor driving circuits 34, 35, and 36 for driving drive motors 3m, 6m, and 13m for driving the driving roller 3, the pickup roller 6, and the gate rollers 13 according to the driving instructions from the controller 33; and a head driving circuit 37 which controls the liquid ejection of the liquid ejecting heads 11 according to the print reference signals and the image data from the controller 33. The print-reference-signal generating circuit 32 and the head driving circuit 37 are provided for each magnetic sensor 103 and each liquid ejecting head 11 corresponding thereto. The controller 33 outputs the print reference signals from the print-reference-signal generating circuit 32 to the corresponding head driving circuits 37.

When image data from the image-data forming device 40 is input and a print Instruction is given, the controller 33 drives a print medium tray (not shown) and the pickup roller 6 according to known procedures to convey the print medium 2 to the gate rollers 13 and drives the driving roller 3. The controller 33 then drives the motor driving circuits and the head driving circuits according to known procedures to control the conveyance of the print medium 2 and the recording of image data.

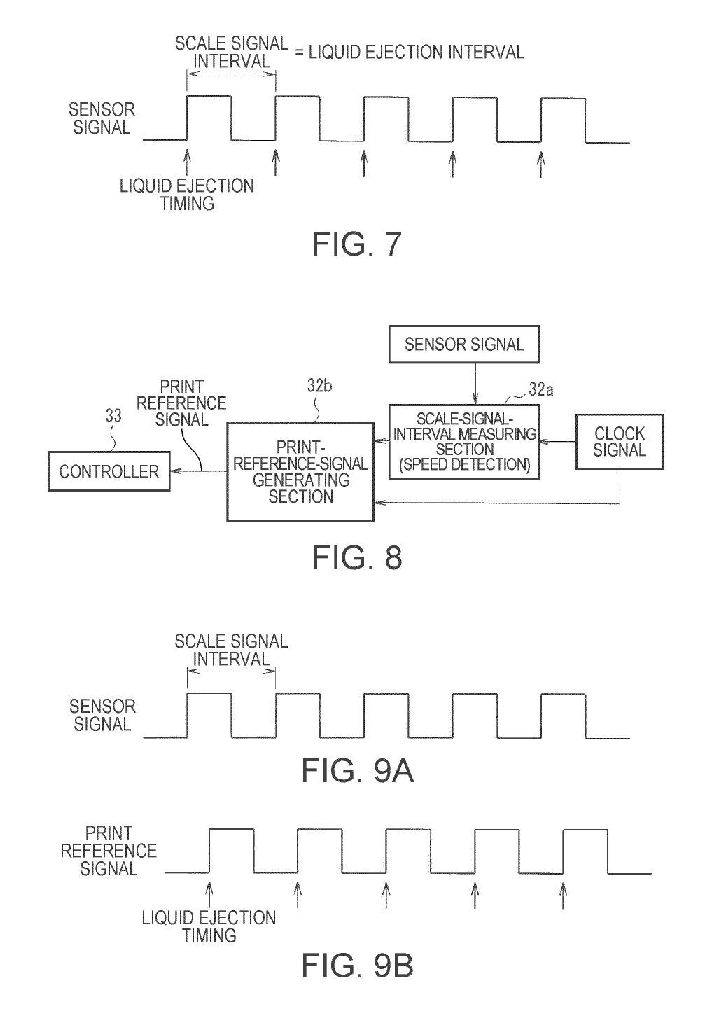

For example, if the intervals of the patterns of the magnetic pattern 102 are set to the intervals of liquid ejection, the print-reference-signal generating circuit 32 outputs print reference signals indicative of the timing of liquid ejection to the controller 33 at the timing that the detection signals from the magnetic sensors 103 rise, as shown in FIG. 7.

For example, if the conveying speed of the conveyor belt 1 or the print medium 2 is detected from the detection signal of the magnetic pattern 102, according to which the liquid ejection timing is determined, a scale-signal-interval measuring section 32a, which is shown in the block diagram of FIG. 8 showing the functional structure of the print-reference-signal generating circuit 32, counts the intervals of the pulse signals, which are generated by the magnetic sensors 103 at regular intervals, using a reference clock signal to detect the conveying speed of the conveyor belt 1, as shown in FIG. 9A. A print-reference-signal generating section 32b calculates the division ratio of the clock signal using the conveying speed and divides the clock signal using the calculated division ratio to generate the print reference signal that rises at dot intervals, as shown in FIG. 9B.

Here, the magnetic pattern 102 is disposed on the inner circumference of the conveyor belt 1 stretched between the driving roller 3 and the driven roller 4, as described above. Accordingly, the width of the conveyor belt 1 may be set depending on the maximum width of the print medium 2. Therefore, the width of the apparatus corresponding to the width of the conveyor belt 1 can be reduced by the width corresponding to the width of the linear scale as compared with the case in which the linear scale is disposed at one end of the length of the conveyor belt 1, reducing the size of the apparatus correspondingly.

Moreover, the positions of the driving roller 3 and the driven roller 4 facing the magnetic pattern 102 have the grooves 3a and 4a, respectively, such that the magnetic layer 101 having the magnetic pattern 102 does not come in contact with the grooves 3a and 4a. This structure can prevent the magnetic pattern 102 from wearing by friction or the like even if the magnetic pattern 102 is provided on the inner circumference of the conveyor belt 1.

Since the mist protection cover 105 is provided on both sides of the driving roller 3 and the driven roller 4, as shown in FIG. 5, the occurrence of magnetic pattern 102 detection errors due to mist can be prevented. Particularly, the adhesion of mist is a major problem for sensors used in printing apparatuses. For optical sensors, the light reflectance and transmittance are changed by the mist adhered to the linear scale and the sensors, causing the possibility of inaccurate position signals and signal dropouts. Such problems occur also with magnetic sensors. If the magnetic sensors 103 are contact magnetic encoders, the gap between the magnetic layer and the sensor surface is changed by adhesion of mist to decrease the signal amplitude, causing duty changes, signal dropouts, or other errors.

However, since the magnetic pattern 102 is provided on the inner circumference of the conveyor belt, the influence of mist can be significantly decreased as compared with a case in which a linear scale is disposed on the front surface of the conveyor belt 1, that is, the surface on which the print medium 2 is to be placed. Furthermore, the presence of the mist protection cover 105 prevents mist from entering the magnetic sensors.

The structure in which the linear scale is disposed at one end of the length of the conveyor belt 1 must prepare for entrance of mist to prevent mist from entering the sensors, which may cause the disadvantage of increasing the size of the apparatus correspondingly. In contrast, according to the embodiment of the invention, the sensors are disposed on the inner circumference of the conveyor belt 1, as described above. Therefore, entrance of mist can easily be prevented only by providing the mist protection cover 105 on the sides of the driving roller 3 and the driven roller 4, for preventing mist from entering the inner circumference of the conveyor belt 1, without an increase in the size of the apparatus.

When the movement of the conveyor belt 1 of the electrostatic adhesion type is detected by a contact sensor such as a magnetic sensor, the charged front surface is not used for sensing by the contact sensor. This prevents failure of the magnetic sensors 103 due to static electricity or the like.

In the case where the linear scale is disposed at one end of the length of the conveyor belt 1, a sensor for detecting the scale patter must be provided on the side or the like of the conveying path of the print medium 2. This makes it more difficult to reduce the size of the apparatus in the direction of the width of the print medium 2. In contrast, as described above, the magnetic pattern 102 is disposed on the inner circumference of the conveyor belt 1. This increases the flexibility of the mounting positions of the magnetic sensors 103 and eliminates the need for disposing the magnetic sensors 103 along the conveying path of the print medium 2, thus reducing the width of the apparatus.

Moreover, the position detection is performed at each liquid ejecting head 11 to determine the timing of liquid ejection as described above. Therefore, even if the conveyor belt 1 has expansion, contraction, or distortion, accurate position detection is allowed, thereby preventing color shift.

While the first embodiment has been described for the case in which the magnetic layer 101 is disposed in the center of the width and along the length of the conveyor belt 1, as shown in FIG. 2, the magnetic layer 101 may not necessarily be disposed there, but may be disposed in any position that faces the liquid ejecting heads 11. Thus, the printing apparatus can be further reduced in size by adjusting the position of the magnetic layer 101 and the magnetic sensors 103.

A second embodiment of the invention will next be described.

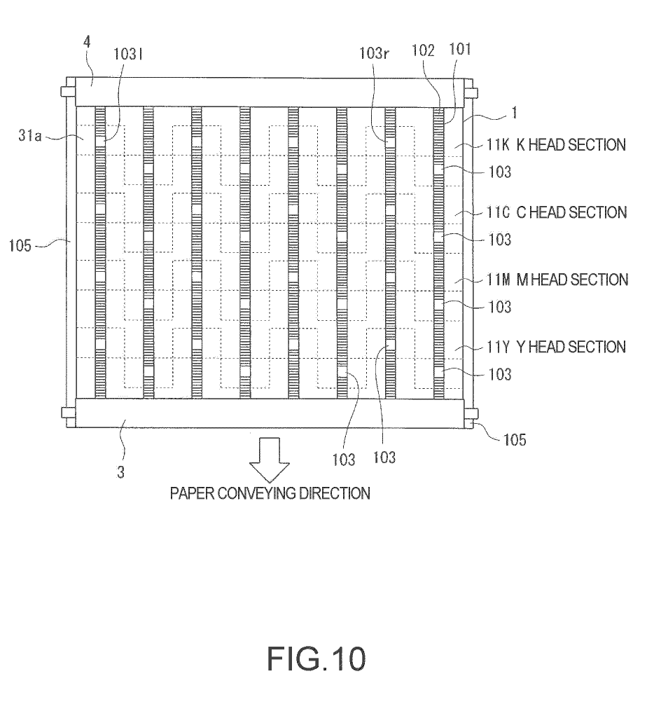

The second embodiment employs a divided-type liquid ejecting head 11, as shown in FIG. 10, in place of the line-type liquid ejecting head 11 of the first embodiment.

As shown in FIG. 10, the second embodiment includes a head 11K that ejects black, a head 11C that ejects cyan, a head 11M that ejects magenta, and a head 11Y that ejects yellow arranged in order from the upper stream in the conveying direction. The heads 11K to 11Y each have a plurality of divided heads 31a in a zigzag manner, each having a specified recording width and having nozzles for ejecting liquid, as shown in FIG. 10. The recording width of each divided head 31a continues along the width of the print medium 2 to be conveyed by the conveyor belt 1 to cover the whole width of the print medium 2.

Assuming the center of the width of each divided head 31a and the print medium 2 conveying direction is the representative position of the divided head 31a, in the side of the inner circumference of the conveyor belt 1, a plurality of the magnetic layers 101 each having a linear scale formed of the magnetic pattern 102 is disposed longitudinally in the positions opposed to the representative positions of the divided heads 31a. The positions of the driving roller 3 and the driven roller 4 facing the magnetic layers 101 have the grooves 3a and 4b, respectively, as in the first embodiment. Thus, the magnetic layers 101 are housed in the respective grooves 3a and 4b of the rollers to prevent the magnetic patterns 102 from wearing due to friction.

The magnetic sensors 103 for detecting the magnetic patterns 102 are disposed in the positions of the insulating platen 104 facing the magnetic patterns 102 and the representative positions of the divided heads 31a, the platen being in contact with the inner circumference of the conveyor belt 1 and over the entire width. The magnetic sensors 103 are provided individually for the divided heads 31a.

The control unit 30 executes the process similar to that of the first embodiment according to the detection signals of the magnetic sensors 103. In this case, the control unit 30 controls the ejection timing of the divided heads 31a corresponding to the magnetic sensors 103 according to the detection signals of the magnetic sensors 103.

Accordingly, the second embodiment also provides the same advantages as those of the first embodiment. Furthermore, the second embodiment allows a difference in movement of the conveyor belt 1 between the right and left since the plurality of magnetic sensors is disposed along the width of the conveyor belt 1, as shown in FIG. 10. Thus, the displacement of landing of liquid dots caused by the distortion and meandering of the conveyor belt 1 can be corrected by detecting a difference in belt movement between the right and left and regulating them according to the difference.

The correction uses the detection signals of sensors at both ends among the magnetic sensors 103 arranged in the same line along the width of the conveyor belt 1, for example, in FIG. 10, sensors 103l and 103r, from which a difference in conveying speed between the right and left of the conveyor belt 1 is estimated. Thus, the conveying speed and the skew of the print medium 2 are regulated so as to eliminate the estimated difference in conveying speed between the right and left, thereby preventing the meandering and the like of the print medium 2.

Also in this case, the presence of the mist protection cover 105 that covers the entire circumference of the conveyor belt 1 on the side of the driving roller 3 and the driven roller 4 reduces detection errors due to mist.

A third embodiment of the invention will next be described.

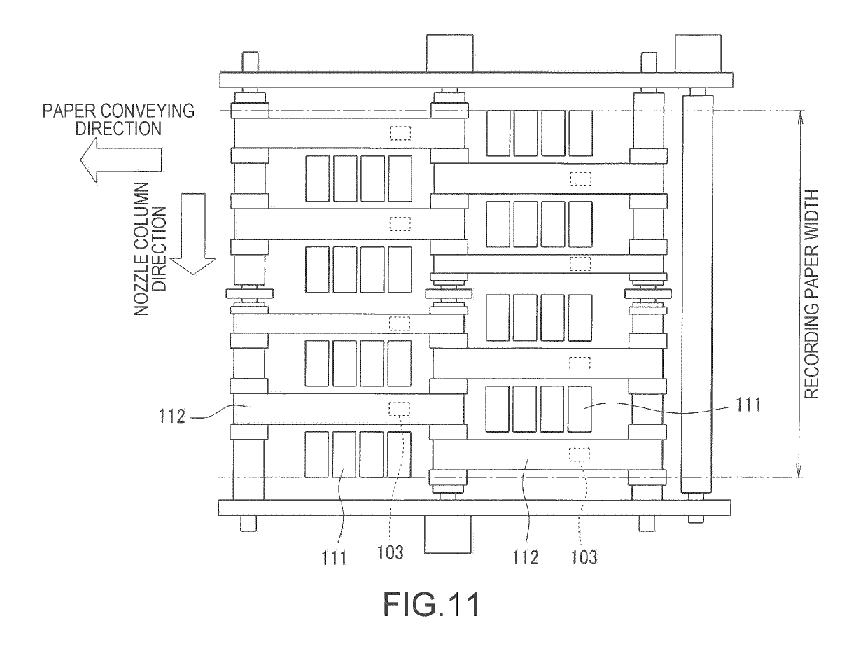

As shown in FIG. 11, the third embodiment is an application to a divided belt printer in which the conveyor belt 1 is divided. In the case of the divided belt type, a plurality of divided belts 112 is displaced in a staggered configuration in the conveying direction so as to be next to each other alternately in the width direction. Divided heads 111 are disposed between the divided belts 112, with the conveying path of the print medium 2 sandwiched therebetween.

Therefore, in this case, the magnetic sensor 103 corresponding to the divided heads 111 are disposed on the divided belts 112 adjacent to the respective divided heads 111, with the conveying path of the print medium 2 therebetween. For example, assuming that the uppermost stream heads of the divided heads 111 in the conveying direction are the representative positions of the divided heads, the magnetic sensors 103 are disposed at the positions of the divided belts 112 adjacent to the divided heads 111 facing the representative positions. The timings of liquid ejection of the divided heads 111 are determined according to the detection signals of the magnetic sensors 103, respectively, by the same procedure as that of the first embodiment.

Accordingly, the divided belt printer can also offer the same advantages as those of the first embodiment.

With the conventional divided belt type, the divided heads 111 and the divided belts 112 are not opposed. Therefore, to detect the position of the conveyor belt 1 at the positions of the divided heads 111 without interference with the conveyance of the print medium 2, another belt for mounting the linear scales must be provided at the positions facing the divided heads 111, and their scale patterns must be detected at the positions of the divided heads 111. This makes it difficult to reduce the size of the apparatus.

However, when the magnetic patterns 102 are disposed on the back of the divided belts 112 adjacent to the divided heads 111, the position of the conveyor belt 1 can be detected at the positions of the divided heads 111 without an additional linear-scale mounting belt, thus reducing the size of the apparatus.

Moreover, the divided belts 112 and the divided heads 111 adjacent to each other are associated with each other so that the divided heads 111 are moved at the timing of the movement of the adjacent divided belts 112. Therefore, even if the movements of the divided belts 112 are different, accurate liquid ejection timing of each divided head 111 can be detected by moving the corresponding divided head 111 at the timing of the movement of the adjacent divided belt 112. This prevents displacement of liquid-dot landing positions caused by changes in movement of the divided belts 112.

In the foregoing embodiments, the conveyor belt 1 and the divided belts 112 correspond to a conveyer belt with a linear scale, the magnetic sensors 103 correspond to scale-pattern detection unit, the print-reference-signal generating circuit 32 corresponds to print-timing determination unit, and the head driving circuit 37 and the liquid ejecting heads 11 correspond to printing unit.

The mist protection cover 105 corresponds to foreign-matter protection unit, and the liquid ejecting heads 11 and the divided heads 111 correspond to liquid-ejecting head unit.

Liquid ejected from the liquid-ejecting head unit of the invention is not particularly limited; for example, liquid containing the following various materials (including suspension and emulsion dispersions), such as ink containing color filter materials, light-emitting materials for forming electro luminescence (EL) layers of organic EL devices, fluorescent materials for forming phosphor on the electrodes of electron emitting devices, fluorescent materials for forming phosphor on plasma display panels (PDPs), migrating materials for forming migration substances on electrophoresis devices, bank materials for forming a bank on the surface of a substrate, various coating materials, liquid electrode materials for forming electrodes, particle materials for forming spacers for forming a fine cell gap between two substrates, liquid metal materials for forming metal wires, lens materials for forming micro lenses, resist materials, and light diffusing materials for forming light diffusers.

In this invention, the print medium to which liquid is ejected is not limited to paper such as recording paper but other media such as films, woven fabrics, and unwoven fabrics or various works including various substrates such as glass substrates and silicon substrates.

What is claimed is:

1. A conveyor belt with a linear scale, for transferring a print medium, the conveyor belt comprising:
a magnetic layer having a magnetic pattern serving as a linear scale on the inner circumference of the conveyor belt along the direction of conveyance of the print medium.

2. A conveyor-belt driving system in which a conveyor belt is stretched between a driving roller and a driven roller, wherein
a conveyor belt with a linear scale is used, the conveyor belt having a magnetic layer including a magnetic pattern serving as a linear scale on the inner circumference of the conveyor belt along the direction of conveyance of the print medium.

3. The conveyor-belt driving system according to claim 2, wherein the portions of the driving roller and the driven roller facing the linear scale each have a circumferentially continuous groove.

4. A printing apparatus for printing characters, figures, or images by ejecting fine liquid from a plurality of nozzles to form fine particles on a print medium, the printing apparatus comprising:
a conveyor-belt driving system in which a conveyor belt with a linear scale is used, the conveyor belt having a magnetic layer including a magnetic pattern serving as a linear scale on the inner circumference of the conveyor belt along the direction of conveyance of the print medium;
scale-pattern detection unit that detects the scale pattern of the linear scale on the conveyor belt;
print-timing determination unit that determines the timing to print on the print medium according to the scale pattern detected by the scale-pattern detection unit; and
printing unit that prints on the print medium at the print timing determined by the print-timing determination unit.

5. The printing apparatus according to claim 4, wherein
the printing unit includes a plurality of individually controllable liquid-ejecting head units;
the conveyor belt with a linear scale is opposed to the plurality of liquid-ejecting head units;
the scale-pattern detection unit is opposed to the plurality of liquid-ejecting head units, with the conveyor belt with a linear scale in between; and
the print-timing determination unit determines print timing according to the detection signal of the scale-pattern detection unit opposed to the liquid-ejecting head units.

6. The printing apparatus according to claim 4, wherein:
the conveyor belt with a linear scale includes a plurality of individually controllable divided belts displaced in a staggered configuration in the print-medium conveying direction in such a manner as to be next to each other alternately along the width of the print medium;
the printing unit includes a plurality of individually controllable liquid-ejecting head units disposed between the divided belts, with a print-medium conveying path sandwiched therebetween;
the scale-pattern detection unit are provided individually for the liquid-ejecting head units, in the positions opposed to the linear scales of the divided belts adjacent to the liquid-ejecting head units, with the print-medium conveying path sandwiched therebetween and at same positions as the liquid-ejecting head units in the conveying direction; and
the print-timing determination unit determines print timing according to the respective detection signals of the scale-pattern detection unit opposed to the liquid-ejecting head units.

7. The printing apparatus according to claim 4, further comprising foreign-matter protection unit that prevents foreign matter from entering the conveyor-belt inside space formed by the conveyor belt on the sides of the conveyor-belt conveying path.
